(19) United States
(12) Patent Application Publication
(10) Pub. No.: US 2012/0253853 A1
(43) Pub. Date: Oct. 4, 2012

(54) Institutional Endowment Using Donor Originated Life Insurance

(75) Inventors: Jon Cameron, Dallas, TX (US); Michael Schornstein, Dallas, TX (US)

(73) Assignee: Michael Schornstein, Dallas, TX (US)

(21) Appl. No.: 13/493,288

(22) Filed: Jun. 11, 2012

(51) Int. Cl. G06Q 40/08; G06Q 40/00

(52) U.S. Cl. 705/4; 705/39

(57) ABSTRACT

A method of converting a series of donations by a donor to an institution so the institution is able to maintain premium payments on a donor-owned life insurance policy.

### BACKGROUND

1. Field of Invention

The invention related to the system and method of using donor-originated life insurance for the endowment of an institution.

2. Background of the Invention

The present invention is useful and novel method for using life insurance to fund an institution.

It has been a long established practice for individuals to use insurance to fund endowments to institutions. This is traditionally done by individual planning when the donor wishes to be recognized for a larger donation than capital funds would permit. By purchasing a life insurance plan, the endowment is recognized by the institution as the death benefit amount. Thus, a donation of $500,000 could be afforded the same status and recognition as a multi-million dollar endowment. Although the life insurance donation of $500,000 could be spread out over many years of insurance premium payments, the endowment can be recognized as soon as the nomination listing the institution is made by the donor.

For instance, Donor A provides a cash payment of $2,500,000 USD to a university to fund the athletic department. For this donation, the athletics department provides a guest suite for home games and access to department events. Donor B purchases a life insurance policy with total premiums of $500,000 and a death benefit of $5,000,000 USD. The payment schedule includes an initial payment of $50,000 and quarterly payments of $5,900. While Donor B spent less than 3% of Donor A in the first year, and 20% of Donor A overall, Donor B would be afforded greater recognition and additional benefits not offered the “smaller” donation of $2,500,000.

Not including the time value of money, for the same cash used by Donor A, Donor B could endow five (5) institutions at $5,000,000 USD.

For the donor, the general benefits of using life insurance for endowment are clear.

The benefits to the university are less tangible. For instance, the purchase of life insurance for the benefit of institutional endowment is often done without the awareness of the institution itself. As part of periodic financial planning, an advisor may privately suggest to the client the use of life insurance to accomplish a number of goals. For this discussion, the advisor would recommend that instead of setting aside proceeds for the funding of a local church, for example, the donor uses the same funds to purchase life insurance to provide a greater endowment at the time of death. Without notifying the institution, the policyholder nominates the institution as the beneficiary.

This has a number of problems for the institution. Without knowledge of a potential endowment, financial planning is more difficult for the institution. Most importantly, under the Insurance Act of 1938, Section 39, the owner may change the nominee at any time before death. If, in this example, the donor would move to a new community and attend a new church, he would be free to change his nomination with the new church as beneficiary.

In fewer cases, the donor may approach the institution for assistance in planning a death benefit donation. The development officer could suggest the use of life insurance in order to grow the amount of the benefit. At this point, the development officer would recommend an insurance agent or recommend the donor discuss the option with their current insurance agent. Unless they are a registered insurance agent, the development officer is legally prohibited for any further participation including providing any solicitation such a brochure; providing an application; providing a non-binding quote; or receiving, collecting or transmitting a premium; or selling the policy. So the donation advocate loses control of the donation and turns the decision making over to a third party that does not have the institution as the client.

### Endowment Insurance Policy

There are life insurance policies specifically identified as endowment life insurance policies. A customary endowment life insurance policy, or endowment policy, is a contract designed to pay a lump sum at the maturity of the policy or in the advent of illness or death. Endowment policies can be cashed out earlier and the owner of the policy receives a reduced surrender value.

An endowment policy “with profits” has two distinctive characteristics. One, the endowment policy provides a guaranteed payout but the payout can increase on the basis of fund performance of the underlying security. To encourage long term planning, during periods of lower market performance penalties are triggered to prevent withdrawal. These penalties are viewed as positive reinforcement of the primary purpose of the endowment policy: to encourage the incentive to save.

Using a “low cost” with profits endowment policy, the guaranteed maturity value starts as only a fraction of the sum assured and therefore may not be able to fully reach the payout target. Sum assured is the amount of the policy that is guaranteed to be paid out.

A more expensive “with profits” endowment policy is the “full” endowment policy. As it sounds, the policy guarantees to pay at least the full value of the sum assured from the start of the policy. By adding in the “with profits” capital gains, the final payout would be much higher than the sum assured.

While these policies may be suitable to fund an institution, particularly a with profits endowment policy, that is not their specific function despite the policies' terminology. Typically, these policies are used to insure the holder of debt.

These endowment policies are presented as prior art to distinguish from the present invention of using a policy for the purposes of endowing an institution.

### Conclusion

While the benefits of using life insurance for endowment are plentiful for donors, the reliance on life insurance by institutions for endowment is clearly problematic for the purposes of planning and bears unpredictable risk.

FIG. 1 of the drawings will more fully explore traditional models for the use of life insurance to endow institutions.

### Indirect Use of Life Insurance to Fund Institutions

Life insurance can also purchase future rights to receive benefits provided by an institution. For instance, life insurance is typically used by parents or grandparents to plan for a child's tuition requirement to attend an institution of higher education. The Gerber Life Insurance Company's “Gerber College Savings Plan” allows persons with insurable interest to purchase life insurance as soon as a child is born. This type of policy is not intended to provide either the family or institution a benefit at the time of death. Instead, the life insurance is used to provide fixed premium payments, stable growth, and a fixed payout.

While an educational institution is intended to benefit from the policy in the form of tuition, this type of funding is indirect because the benefitting institution is not designated, whether through permanent conveyance or nomination, at any point in the policy term. These tuition savings life insurance policies also do not have penalties in the event the policy is used for non-educational purposes. Additionally, many of these policies provide incentives to not use the policy for tuition and instead encourage the student to carry the policy past typical undergraduate ages. This can be useful if the policy's value is significantly higher when college loans begin payment terms.

### Funding an Institution Using Life Insurance Institutionally Owned

Found within the patent art are several patents which specifically address the use of life insurance to fund an institution. “Method for funding an organization,” U.S. Pat. No. 7,451,104 claims the invention of the institution buying life insurance policies on a person of insurable interest associated with the primary institution. The patent claims the use of asset-backed securities to then fund the life insurance policies which are then placed at a secondary entity.

The same inventors filed “System for Funding an Organization,” United States Patent Application 20080294566, now abandoned, on the use of life insurance for funding a bankrupt institution. This application also claims the use of remote secondary entity with the same insurable interest as the bankrupt primary institution. The life insurance policy is self-funding and produces “lumpy cash flows when paid to said beneficiary.” These lumpy cash flows are then swapped by a provider to produce smooth, guaranteed cash flows.

Both of these prior art show the well-known process of funding an institution using life insurance by the institution purchasing life insurance on anyone with insurable interest. This is typically thought of key person, or key man insurance. This type of life insurance has no specific legal definition but is characterized by:
a. Purchased by the institution.
b. Premium payments made by the institution.
c. The institution is the beneficiary.
d. The insured is anyone believed to provide unique or important contributions to the business.

Life insurance is a necessary component of key person insurance plan, but in most cases key person disability insurance is also provided. If the key man insurance policy is used to fund an institution, the disability portion of the coverage could be notably absent.

### Insurable Interest

The central element to any life insurance product is the consideration of insurable interest. Insurable interest is defined as a person or entity that would suffer a financial loss, or other kind of loss such as an emotional loss, in the event there is loss or damage to the insured. In the case of life insurance, the beneficiary of the policy must have an insurable interest in the insured individual.

Legal guidelines have been established which generally limit this to certain family member combinations such as spouses, parent/children, brother/sisters and grandparents/grandchildren. A company or public institution may also have an insurable interest on key executives and employees with special knowledge. A creditor would have an insurable interest on the life of the debtor.

There are two exceptions to the laws surrounding insurable interest. They are considered exceptions because the relations between the parties are created by contract or by informal relationship.

The first exception is called viatical settlement which is the sale of a policy owner's existing life insurance policy to a third party. This is usually done by individuals who are terminally ill as defined by various objective tests.

The second insurable interest exception is related to charitable donations. There is a constant flux of federal laws, state laws and taxation rules which variously allow charities to have an insurable interest in individuals, such as donors to the charities. Consider the example of a charity that is reliant on older donors and there is no guarantee that their heirs will continue to give to the same organizations. The charity would seemingly have a clear insurable interest in its donors in order to maintain the operations of the charity. Yet the use of life insurance by charities has viable legislative risk due to the very flux of laws on which they maintain their insurable interest. Even assuming that future legislation would grandfather current policy, there still remains significant risk of civil procedure to challenge the validity of the charity's insurable risk. Civil litigation costs could outweigh the benefits of using life insurance to continue charitable donations after death. Adding even more risk is that taxation rules, which rarely provide the benefit of grandfathering, could significantly alter the future financial return on the use of life insurance plans with non-traditional insurable interest claims.

### Stranger-Owned Life Insurance

Stranger-owned life insurance (STOLI) is the process of an investor soliciting to purchase the insurable interest of individuals. The central issue of STOLI policies is state laws surrounding insurable interest. These laws universally focus on a two-part test. The first is that the insured's death would cost the owner of the policy. This first test is fairly easy to overcome so the law focuses on whether the owner of the policy is gaining benefit from the insured continuing to live. This second test cannot be easily manufactured.

Stranger-owned policies are schemes that overcome the need for the owner of the policy to receive a continuity of life benefit. This is done by either legally borrowing such benefit or exploiting loopholes within insurance laws.

Characteristics of STOLI policies include:
1. Investor solicits the life insurance.
2. The investor does not have a relationship with the person intended to be the insured.
3. The investor uses a 3^{rd} party, such as a charity, to borrow the charity's insurable interest.
4. The investor promises a portion of the death benefit to the charity.
5. The investor makes an initial donation to the charity.
6. The investor offers compensation to the insured including intangible benefits.
7. One agent writes a large number of policies simultaneously.
8. The death benefit is conveyed to the investor.
9. Most importantly, the insured has no intention of using their own resources to fund the premiums. The investor pays for the premiums.

STOLI policies are much lamented by the insurance industry and insurers make concerted effort to punish the insurance agents even if the law permits these policies. The reason is that insurance companies count on insurers to lose interest in the need for the policy. The cancellation of the policy causes the previous premium payments to become shear profit for the insurer. This profit is inherent in the pricing of life insurance so they insurer remains profitable. STOLI policies tend to have very little cancellations and therefore reduce the insurer's return. If STOLI plans are used to fund institutions, eventually other life insurance buyers must start paying for those policies through premium increases.

Investors stand on contract law that a policy contract was issued and those premiums were paid. Therefore, it is an enforceable contract.

### Description of First Key Element of Prior Art

Insurable interest not solicited by the institution. While life insurance is both a useful and attractive option for donors to endow an institution, the institution is unable to legally solicit the use the insurance for the institution's benefit. The reason is state and federal laws define the role of the agent in a way that prohibits anyone but an insurance agent to solicit insurance. This includes conducting tasks of direct response solicitation such as emails, telephonic communication, and printed materials. Regardless of whether the act is done at the request of or by the employment of an insurer, broker, or other person, a person is the legal agent of the insurer for which the act is done. An agent is a licensed individual, not an organization or entity, even if the entity is composed entirely of insurance agents.

As a result, institutions are unable to strategically plan to sell life insurance as a means to fund their endowment requirements unless they specifically train institutional personnel as legal agents and provide an internal “Chinese wall” so that all individuals handling such solicitations and policies are agents.

### Description of Second Key Element of Prior Art

Premium payments are maintained by the donor. Under existing prior art, the donor would obtain a life insurance policy for themselves and then nominate the institution as a beneficiary. The donor is responsible for fulfilling the premium payment requirements to keep the policy in place.

Notably, life insurance companies calculate premiums based on the expectation that a large percent of policies will never pay because the premium payments are abandoned by the insured.

These cancellation rates introduce problems for institution with donations in the form of life insurance. First, the institution is unable to monitor the cancellation of donor policies because they possess no rights to monitor the status of the charitable donations in the advent of a nomination. Therefore, the institution, as the beneficiary, is unable to access the risk or opportunity to make the payments on behalf of the insured. For instance if a policy is near the sum assured amount, it may be in the institution's best interests to maintain the premium payments on the policy.

The institution is also unable to adjust endowment requirements based on cancelled policies. Once the policy is cancelled, it cannot be reinstated. This can essentially leave the institution blind for decades as promised endowments go unmet. The inability for the institution to control risk associated with existing life insurance endowments can make these policies unattractive contribution instruments.

### Description of Third Key Element of Prior Art

Leveraged securities to pay premiums. In life insurance products from the prior art, the institution either self-funds the premium payment or leverages the policy to create a self-funding mechanism.

Therefore the cost of the policy borne by the institution would be reduced from total return. This increases both the risk while simultaneously reducing the total return.

### Description of Forth Key Element of Prior Art

Unspecific designation in nomination. Most commonly, benefit designation such as nominations are specified by the client. The insurance agent may be entirely unfamiliar with the benefitting institution. Often, the resulting written beneficiary doesn't match the institution's organization at the time of the death benefit. The result is the charitable donation doesn't benefit the donor's intended parties.

For instance, a donor wishes to benefit the Tulane University's Athletic Schools's summer athletic trainer program for high school students. The program provides the opportunity for the school to host the nation's top high school trainers for recruiting while providing unique training to the participants. Typically neither the donor nor insurance agent has consulted Tulane on the nomination. In this example, when the death benefit is paid to the University, the administration realizes the Athletic Trainer's Summer Program is not administered by the athletics department, but by the School of Medicine. Thus, the unmanaged beneficiary designation left the funds to two unspecific possible recipients.

### SUMMARY OF THE INVENTION

An invention, which meets the needs stated above, is a system and method which allows a donor to leverage a smaller donation into a larger endowment to fund an institution. The institution's third-party insurance representatives solicit the donor to purchase life insurance with the nominee listed as the institution. The donor gifts the insurance policy to the institution which then uses the donation to fund the life insurance policy. The nominee possibilities are predetermined by the institution.

### Objects and Advantages

Accordingly, besides the objects and advantages of the Institutional Endowment Using Donor Originated Life Insurance, further objects and advantages of the present invention are:
a) Insurable interest in the policy is created because the applicant is insuring their own life.
b) To eliminate the need for institutional self-funding, the donor makes donations to the institution for at least the amount of the premium.
c) To assure properly specified documents, the institution controls the gifting by predetermining the beneficiary.
d) The institution maintains the policy by directing the charitable donation into life insurance premiums. This allows the institution to accurately determine the true value of promised endowments.
e) If the donations cease on a particular policy, the institutional is able to do a risk analysis of self-funding the policy based on the cash value of the policy.
f) Since the policy is funded by donations from the insured, the policy avoids classification as a stranger-owned life insurance policy.
g) Since the policy is funded by donations from the insured, it avoids insurable interest conflicts.

Further objects and advantages of this invention will become apparent from a consideration of the drawings and the ensuing description of the drawings.

### DRAWING FIGURES

The accompanying drawings, which are incorporated in and constitute a part of this specification, illustrate embodiments of the present invention and together with the description, serve to explain the principles of this invention. In the figures;

FIG. 1.—Flow chart depicting the prior art actions of the life insurance agent from the initial solicitation to the commission payment.

FIG. 2.—Flow chart depicting the combined actions, in the present invention, of the institution and life insurance agent beginning at the initial solicitation and ending with benefit payment.

FIG. 3.—Flow chart demonstrating an example of the present invention's data and payment transactions for endowing a institution with a life insurance policy.

### REFERENCE NUMERALS IN DRAWINGS

10 Applicant, Donor, Alumni, Insured
20 Institution, University, Organization, Assignee, Beneficiary
30 Insurance Agent, Agent
40 Insurance Provider, Insurer
50 Application Processor, Processor
110 Solicitation
120 Short form
130 Quote
140 Application, Insurer's application
150 Transfer of interest, Convey, Conveyance
155 Policy Owner, Owner
160 Premium Offer, Offer, Denial
170 Insurance Contract
180 Insurance policy, Life insurance policy
200 Premium Payment, Payment, Initial Payment
210 Donation
220 Commission
230 Benefit Payment

### DETAILED DESCRIPTION OF THE DRAWINGS

Referring to the drawings, in which like numerals represent like elements,

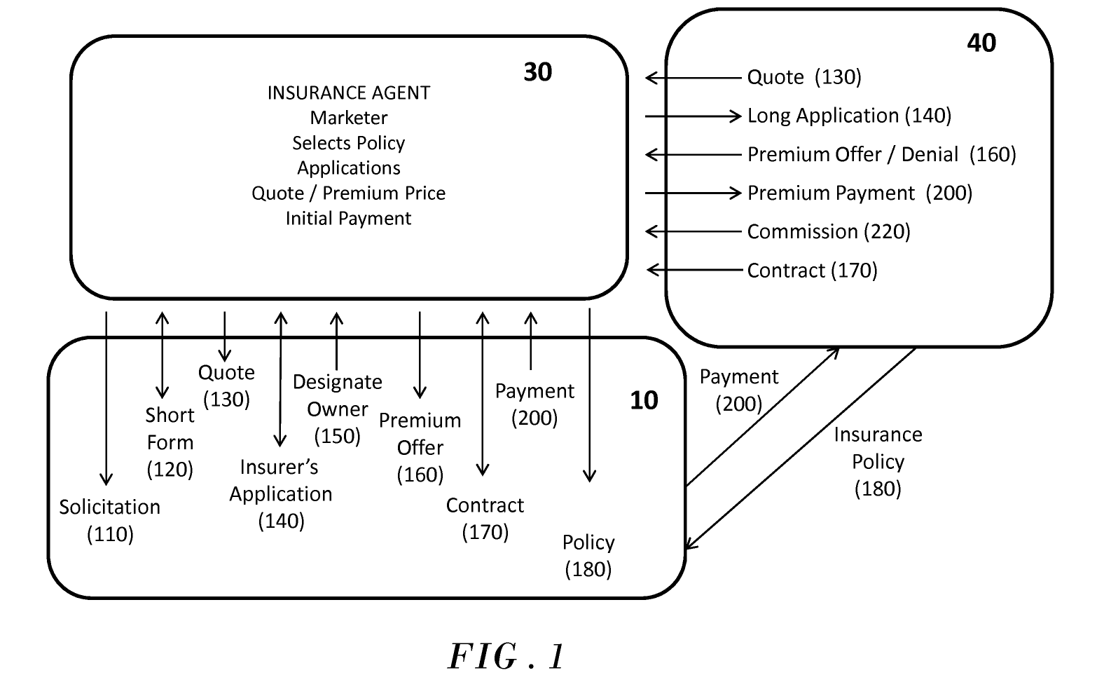

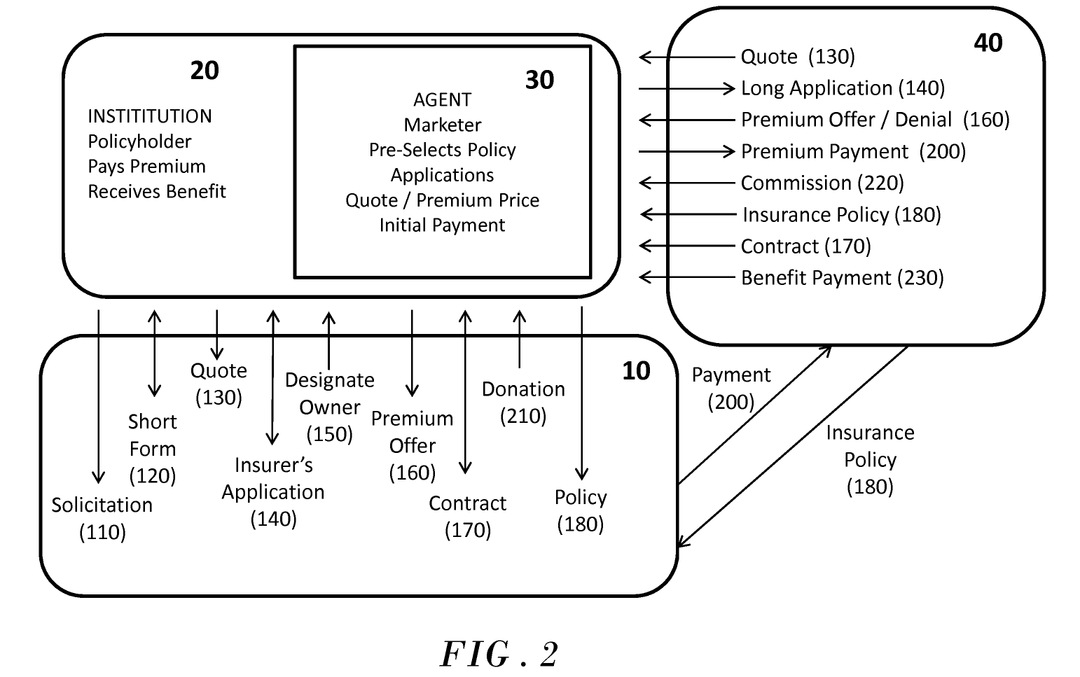

### FIGS. 1 and 2—Party Roles

Turning to FIG. 1, the prior art logic flow chart depicts an insurance agent's 30 current responsibilities in soliciting 110 and processing an insurance policy 180 for life insurance.

Moving left to right and top to bottom in sequential order of execution, the first step is the agent 30 provides a solicitation 110 on behalf of the institution 20. The solicitation 110 will use the brand of the institution 20 and will involve an electronic communication such as email or an announcement at a designated website. This communication can be made by either the insurance agent 30 on behalf of the institution 20 or by the institution 20 identify the agent 30 as the legal representative.

This begins the process of the agent 30 representing the institution 20 while simultaneously assuring the institution 20 does not violate laws that require the activities in this chart to be completed by a legal insurance agent 30.

Typically, after receiving the solicitation 110, the donor 10 can receive a quote 130 by utilizing a computer-implemented interactive form. This allows the agent 30 to be able to provide a quote 130 or compare quotes 130 from various insurance providers 40. Alternately, the agent 30 can contact the donor 10 and interview the donor 10 to determine the initial quote 130. The quote 130 is provided by the insurer(s) 40, using illustrations based on criteria such as sex and age, and may be stored by the agent 30 for later display. The quote 130 may also be instantaneous provided by the insurer 40 and conveyed 150 to the applicant 10 through the agent's 30 online website. The agent 20 is responsible for the function of delivering the quote 130 to the donor 10.

Assuming the quote meets the approval of the applicant 10, the donor 10 notifies the insurer 40 of an interest to continue with the application 140 process. Electronically, this notification by the donor 10 can be executed online by accepting the initial terms of the policy 180.

In subsequent functions, the applicant 10 completes the application 140. There are multiple ways this can be done. The most common method is the insurance agent 30 interviews the applicant 10 and completes the complicated document 140. In this case, the insurer's application 140 can either be a manual form or completed by accessing the insurance agent's computer-implemented interactive system.

The second method to successfully complete the insurer's application 140 is the insurer 40 hires another party 50 to assist the applicant 10. This application processor 50 will then interview the donor 10 and enter the information using automated forms. The processor 50 may also order medical records or have medical test conducted.

The third application completion method is the donor 10 accesses an online system which collects the information keyed by the donor 10 themselves. This generally still requires the intervention of the insurance agent 30 or the processor 50.

At the time of the application 140, the donor 10 may designate the beneficiary 20 of the life insurance policy 180. This is done a number of ways but typically the insurer's application 140 will have a supplemental form for naming the beneficiary 20.

It is also possible to later convey 150 the policy 180 to the institution 20 using a variety of means such as sale, permanent conveyance 150, or nominating a beneficiary. Each of these conveyances 150 relay different rights to the institution 20 which may be either permanent or temporary. The institution 20 may be unaware of the conveyance 150 until the death benefits become due.

Once the application 140 is completed, the insurer 40 makes a decision on whether or not to issue a life insurance policy 180. The insurer communicates the decision with a premium offer or denial 160 to the insurance agent 30 which has the responsibility to relay the decision to the insured 10. The premium offer 160 will include a specific premium payment(s) 200 in order for the insurance policy 180 to be maintained.

The offer 160 will also include an insurance contract 170 for the applicant 10 to sign and return to the agent 30. At the same time, the initial payment 200 would be made by the insured 10.

The agent 30 then forwards the insurance contract 170 and initial payment 200 to the insurer 40.

The insurer 40 subsequently pays a commission 220 to the insurance agent 30.

Once processed, the insurer 40 will issue the insurance policy 180 to the agent 30 or directly to the insured 10. At this point, the role of the agent 30 has ended and future payments 200 are made by the insured 10 directly to the insurer 40.

The donor 10 may notify the institution 20 that they have been assigned 150 an interest in the life insurance policy 180, or they may chose to not disclose this information for certain types of conveyances 150.

Turning now to FIG. 2 of the present invention, the institution 20 and the agent 30 combine roles so that the institution 20 is able to legally solicit life insurance policies 180 to donors 10. For all intents and purposes, the donor 10 believes the solicitations 110 and communications are made between the donor 10 and institution 20.

So FIG. 1 and FIG. 2 are similar except the combined entities in the present invention of FIG. 2 take on the role of both the agent 30 and the institution 20. Combined, the entities still provide a solicitation 110; provide a short form 120 for the purposes of quoting 130; supply and assist in the processing of the insurer's application 140; list a beneficiary 20; make the premium offer 160 received from the insurer 40; process the contract 170 provide by the insurer 40; and deliver the final policy 180 to either the insured 10 or the institution 20.

The two figures vary significantly in the relationship that is established between the institution 20 and the donor 10. While that relationship would be nonexistent or terminate after the policy 180 issued in the prior art, the present invention assures a long-term relationship between the donor 10 and the institution 20 because donor maintains donations 210 to the institution 20 over a period of time.

In both FIG. 1 and FIG. 2, the initial premium payment 200 by the donor 10 would be made by the donor 10 either to the insurance agent 30 or the insurer 40.

Comparing FIG. 1 and FIG. 2, the subsequent premium payment 200 by the donor 10 to the insurer 40 would be eliminated in the present invention. In the prior art FIG. 1, the donor 10 makes the remaining premium payments 200 directly to the insurer 40, bypassing the agent 30.

In FIG. 2 of the present invention, the donor 10 makes no insurance payments 200 after the initial payment 200. Instead, the donor 10 makes a donation 210 to the institution 20. Varying from the prior art, the institution 20 then uses the donation 210 provided by the donor 10 to make subsequent premium payments 200.

In FIG. 2, the institution 20 also receives the benefit payment 230 which may be managed and directed by the agent 30 or by the institution 20 itself.

In the preferred embodiment of the present invention, the assignee 20 or beneficiary 20 would be predetermined. The donor 10 can also permanently convey ownership 150 to the institution 20 after the policy 180 issues.

The present invention allows the institution 20 to become central to the advertising, solicitation 110, processing, and management of a system which they previously were unable to participate or evaluate.

Institution 20, as used herein, comprises businesses, organizations, for profits, nonprofits, departments within an institution, projects, charities, foundations, trusts, educational institutions, religious institutions and government entities.

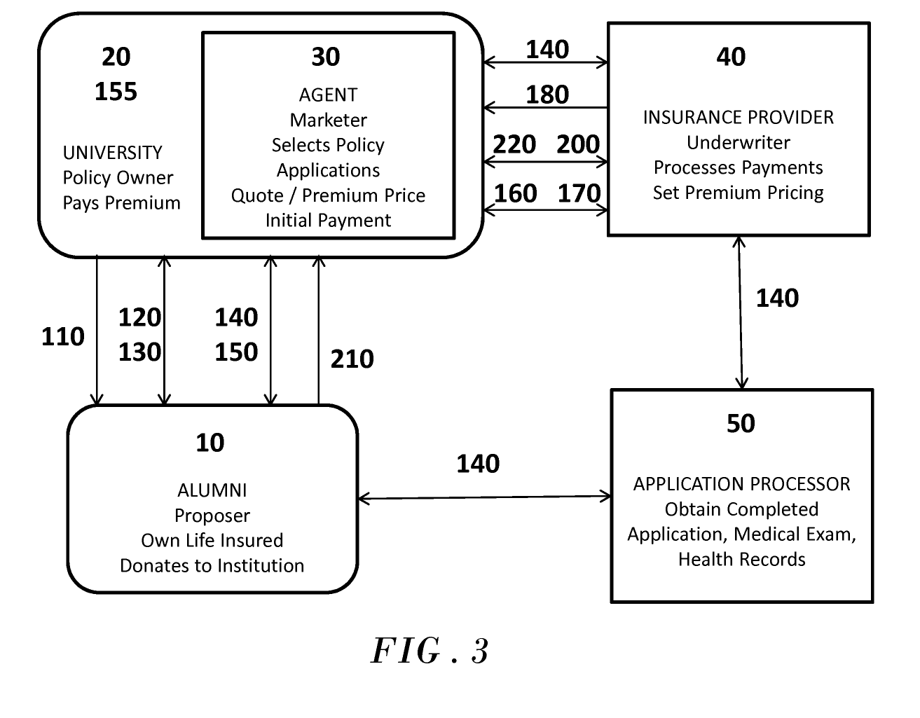

### FIG. 3

Finally, turning to FIG. 3 is an example of the use of the current invention for a university 20 to provide endowment opportunities for alumni 10. This example university 20 wants to offer endowment opportunities to middle and low-upper income graduates. This target is not typically a target of educational institutions 20 because of the smaller size of the donations 210. This makes the target unprofitable for the university's 20 limited staff. In addition, the use of life insurance 180 for this target is problematic for insurance agents 30. Smaller premium policies are as time-consuming for an insurance agent 30 as a much larger policy 180.

In order to overcome these challenges, the university 20 enters into a relationship with an insurance agent 30 to manage and automate the use of life insurance policies 180 to grow endowment. The insurance agent 30 handles all the tasks legally required to be under an agent's 30 control. The agent's 30 role begins from the moment of the first solicitation 110 through the transmittal of the premium offer 160 and insurance contract 170.

The university 20 and agent 30 preselect a life insurance policy 180 which meets the requirements of the university 20 and is priced to be accessible to the target alumni 10.

The agent 30 transmits a solicitation 110 email with the university's 20 branding to the alumni 10 using the university's 20 secure email list. This solicitation 110 may be issued from either a university 20 owned or agent 30 owned computer system. If it is desirable to use the university 20 system, the transmission of the solicitation 110 is overseen by the agent 30 as required by local laws.

Once received, the alumni 10 has the option to click a link and input basic data to receive an instant quote 130 previously supplied to the insurance agent by the insurance provider 40. The form can ask for a very limited amount of information such as age or birth date; and gender. In an embodiment of the present invention, the quote 130 could be provided in the solicitation 110 based on the university's 20 profile of the alumni 10.

The email may also provide a link to online content about the endowment opportunity. This allows the information to be organized in a nonlinear format required by email presentations. The same online content can be the same destination as the short form 120 and quote 130 engine.

After reviewing the instant quote 130, the alumni 10 can select to continue the process for obtaining life insurance 180 to endow the university 20. This will initiate the insurer's application 140 by sending an electronic notice to any combination of the university 20, insurance agent 30 and insurance provider 40. A short form 120 will ask for more detailed information such as the name of the insured 10, amount of donation 210, pay period, and institutional owner 20. Typically, the insurance provider 40 uses an outside company, or application processor 50, to automate the completion of the insurer's application 140 processes. Using computer-implemented interactive systems, the application processor 50 will work with both the agent 30 and alumni 10 to complete the application 140 requirements of the insurer 40. This may include obtaining medical records from the alumni's 10 physician and ordering additional medical tests.

Once the application 140 is completed, it is forwarded to the insurance provider 40 for a decision on making an offer or denial 160.

In the most preferred embodiment of the present invention, the application 140 is preloaded with the nomination of interest 150 of the insurance policy 180 and associated benefits 230 from the alumni 10 to the university 20. However, the donor 10 can also permanently convey ownership 150 to the institution 20 after the policy 180 issues.

If an offer 160 is made by the insurer 40 and then accepted by the alumni 10, the alumni 10 makes a premium payment 200 to the insurer 30 for the value of the initial premium payment 200. Simultaneously, the donor 10 can make donation 210 to the university 20 for at least the value of the second premium payment 200. The payment 200 may also be for other periods, such as quarterly, or even for the entire amount of the premiums 200.

The university 20 or agent 30 processes the donation 210 from the alumni 10 and converts the donation 210 into the premium payment 200.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus composed of a list of elements, that may include other elements not expressly listed or inherent to such process, method, article, or apparatus.

### Advantages

From the description above, a number of advantages become evident for the “Institutional Endowment Using Donor Originated Life Insurance.” The present invention provides all new benefits for participating parties such as the institution, the donor, and the insurance agent, including:
a) By automating the process using computers, the institution is able to solicit donors to purchase life insurance using remote insurance agents.
b) By automating the process using computers, insurance agents are able to sell and process low-value life insurance policies that were previously unprofitable to sell.
c) By automating the application process, the agent can preload the assignment of nomination to assure the institutional beneficiary of the policy.
d) By using systems to convert the donation to an insurance payment, the institution can manage risk and accurately track a large portfolio of life insurance assets.
e) By using the donation conversion computer system, the policy avoids classification as a stranger-owned life insurance policy.
f) Using the present invention, automation reduces or eliminates today's paper-centric application.
g) Automation significantly expedites the application process.

What is claimed is:

1. A method for using life insurance for endowing an institution, the method comprising:
a. An institution solicits a donor to purchase an at least one predetermined life insurance policy;
b. Said donor purchases said life insurance policy from an insurer;
c. Said donor conveys transferrable interest of said life insurance policy to the institution;
d. Said donor makes a donation to said institution at least in the amount of a premium payment;
e. Said institution uses said donation amount to make said premium payment.

2. A method of claim 1, wherein said transferrable interest comprises a nomination.

3. A method of claim 1, wherein said transferrable interest comprises an assignment.

4. A method of claim 1, wherein said transferrable interest comprises an endorsement on the policy.

5. A method of claim 1, wherein said transferrable interest comprises a hand-written note on the policy.

6. A method of claim 1, wherein said transferrable interest comprises an absolute assignment.

7. A method of claim 1, wherein said transferrable interest comprises an irrevocable beneficiary.

8. A method of claim 1, wherein said transferrable interest comprises a beneficiary change.

9. A method of claim 1, wherein said life insurance policy comprises a term policy.

10. A method of claim 1, wherein said life insurance policy comprises a whole life policy.

11. A method of claim 1, wherein said life insurance policy comprises a universal life policy.

12. A system for automatically soliciting and processing life insurance applications, said system comprising: a communications system, coupled to a network linked to the internet, configured to transmit an electronic communication from the institution to the donor, to purchase life insurance for donation to said institution, to provide an estimate of the premium payment to support donor's desired donation amount; a processing module comprising a processor, operably coupled to a network via a communications link to an insurer, configured to communicate the donor's applications, to transmit a premium offer, to transmit an insurance contract to the donor, to transmit said insurance contract from the donor, to accept a donation from the donor, to transmit an insurance premium payment; wherein the donor may purchase said life insurance to endow the institution originating the solicitation.

13. The system as recited in claim 12, wherein said insurance premium payment is transmitted to the insurer by the institution.

14. The system as recited in claim 12, wherein said insurance premium payment is transmitted to the insurer by the donor.
